(19) United States
(12) Patent Application Publication
(10) Pub. No.: US 2016/0343266 A1
(43) Pub. Date: Nov. 24, 2016

(54) LOCATION-BASED SUGGESTIONS FOR ATTAINING HEALTH GOALS

(71) Applicant: Toyota Motor Engineering & Manufacturing North America, Inc., Erlanger, KY (US)

(72) Inventor: Tina Brunetti Sayer, Ann Arbor, MI (US)

(21) Appl. No.: 14/719,389

(22) Filed: May 22, 2015

(51) Int. Cl. G09B 19/00; G09B 5/02

(52) U.S. Cl. CPC G09B 19/00; G09B 19/0092; G09B 5/02

(57) ABSTRACT

Arrangements related to assisting a user in attaining a health goal are described. A user may input a predetermined health goal in an application on a portable communication device. The application can track a user's progress toward the health goal. The user's predetermined health goal can be obtained from the application. The current progress toward the health goal can be obtained from the application A destination of current vehicular travel can be determined. Responsive to determining that the health goal is not met, a suggestion for making progress toward the health goal can be determined based on the determined, destination of current vehicular travel A message can be presented to the user. The message can include the determined suggestion.

### FIELD

The subject matter described herein relates in general to goal-setting and, more particularly, to assisting individuals in attaining predetermined goals.

### BACKGROUND

An individual may set a goal relating to his or her health. There are numerous software applications available that enable a user to automatically track his or her progress toward attaining the goal. As an example, a software application may monitor the number of steps taken by an individual whose goal is to walk a certain distance in a day. As another example, a software application may estimate the number of cal odes consumed or burned by an individual whose goal is to consume or burn a certain number of calories per day. These software applications are typically downloaded onto and executed on a portable electronic device.

### SUMMARY

In one respect, the subject matter described herein is directed to a method for assisting a user in attaining a health goal, The method includes obtaining, a predetermined health goal from an application cm a portable communication device. The method also includes obtaining a current progress toward the health goal from the application. The method further includes determining a destination of current vehicular travel. The method includes, responsive to determining that the health goal is not met, determining a suggestion for making progress toward the health goal based on the determined destination of current vehicular travel. The method includes presenting a message. The message can include the determined suggestion.

In another respect, the subject matter described herein is directed to a system configured to assist a user in attaining a health goal. The system includes a media device. The media device includes a processor. The processor can be programmed to initiate executable operations. The executable operations can include obtaining a predetermined health goal from an application on a portable communication device. The executable operations can also include obtaining a current progress toward the health goal from the health application. The executable operations can further include determining a destination of current vehicular travel. The executable operations can include, responsive to determining that the health goal is not met, determining a suggestion for making progress toward the health goal based on the determined destination of current vehicular travel. The executable operations can include presenting a message. The message can include the determined suggestion.

In another respect, the subject matter described herein is directed to a computer program product for assisting a user in attaining a health goal. The computer program product includes a computer readable storage medium having program code embodied therein. The program code can be executable by a processor to perform a method. The method includes obtaining a predetermined health goal from an application on a portable communication device. The method also includes Obtaining a current progress toward the health goal from the application. The method further includes determining a destination of current vehicular travel. The method includes, responsive to determining that the health goal is not met, determining a suggestion for making progress toward the health goal based on the determined destination of current vehicular travel. The method includes presenting a message. The message can include the determined suggestion.

### BRIEF DESCRIPTION OF THE DRAWINGS

FIG. 1 is an example of a system for assisting a user in attaining a health goal.

FIG. 2 is an example of a portable communication device.

FIG. 3 is an example of a media device.

FIG. 4 is an example of a method for assisting a user in attaining a health goal.

FIG. 5 is an example of a message presented on a display, the message including a suggestion to assist a user in attaining a health goal.

### DETAILED DESCRIPTION

This detailed description relates to assisting a user in attaining a health goal. More particularly, information about a user's predetermined, health goal and the current progress toward the health goal can be obtained from an application on a portable communication device. Responsive to determining that the health goal is not met, a suggestion for making progress toward the health goal can be determined based on a determined destination of current vehicular travel. A message including the determined suggestion can be presented. The present detailed description relates to systems, methods and computer program products that incorporate one or more of such features. In at least some instances, such systems, methods and computer program products can actively assist users in meeting their goals.

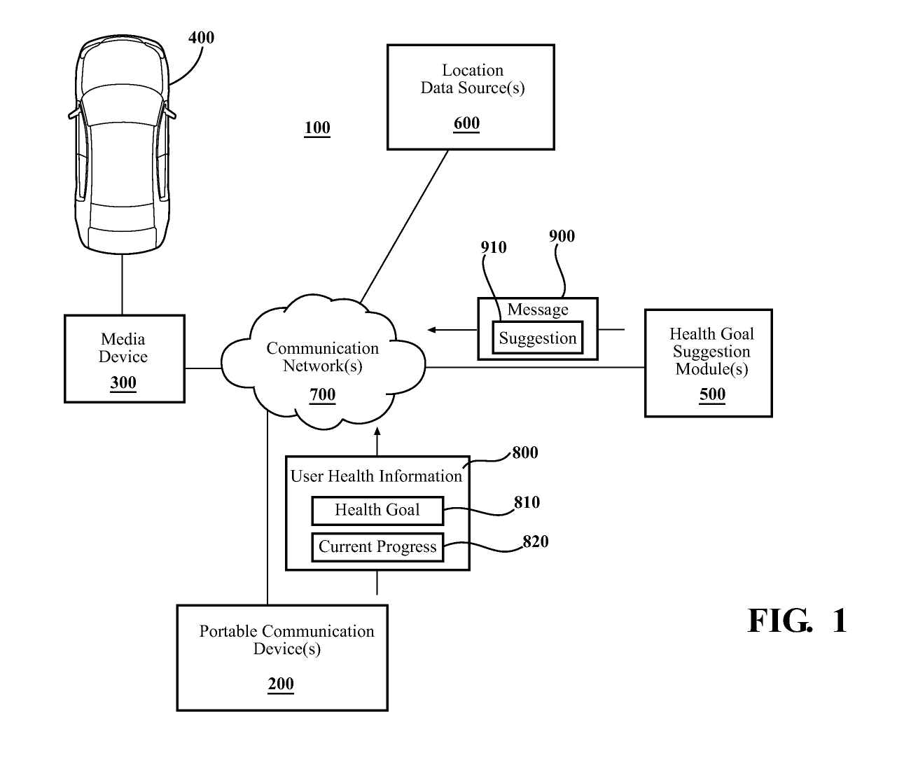

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding, of the embodiments described herein. However, it will be understood by those of ordinary skill in the art that the embodiments described herein can be practiced without these specific details.

FIG. 1 is an example of a system 100 for assisting a user in attaining a health goal. Some of the possible elements of the system 100 are shown in FIG. 1 and will now be described. It will be understood that it is not necessary for the system 100 to have all of the elements shown in FIG. 1 or described herein. The system 100 can include a portable communication device 200, a media device 300, and a vehicle 400. The system 100 can include one or more health goal suggestion modules 500. The system 100 can include one or more location data sources 600. Each of these elements of the system 100 will be described in turn below.

The portable communication device 200 can be any suitable device including, for example, a cellular telephone, a smart phone, a personal digital assistant (“PDA”), a tablet computer, a fitness tracker, an activity tracker, a digital reader, a handheld device having wireless connection capability, a computer (e.g., a laptop), a portable computing device, an entertainment device (e.g., an audio or video device). The portable communication device 200 can be configured to communicate via a wireless medium. The portable communication device 200 can include any suitable operating system.

In one or more arrangements, the portable communication device 200 can be configured so as to be wearable by a user. For instance, the portable communication device 200 can be a smart watch, smart, eye glasses, smart jewelry (e.g., neckless, earrings, bracelets, etc.), and/or smart clothing (e.g., a shirt, hat or other article of clothing enabled for wireless communication).

The “media device” is defined as a component or group of components that can present audial and/or visual output to as user. Examples of such output can include text, audio, video, animation, still images, mapping, directions, and interactivity. The media device 300 can include one or more user interface elements. A “user interface element” is defined as a component or is group of components that enables a user to interact with a machine. The term user interface element includes graphical user interface elements. A “graphical user interface element” is defined as an image or a portion of an image that presents information to a user or allows the user to interact with a device through a display.

In one or more arrangements, the media device 300 can include one or more components and/or user controls relating to: audio systems, video systems, navigation systems, monitoring systems, entertainment systems, communication systems, and/or combinations thereof, just to name a few possibilities. For example, the media device 300 can include one or more components and/or user controls relating to: radio (e.g., AM/FM, satellite, etc.), Compact Discs (CDs), DVD, Blu-Ray Disc (BD), MP3, navigation, Global Positioning Systems (GPS), vehicle backup monitoring, vehicle back seat monitoring, and/or Bluetooth, just to name a few possibilities.

In one or more arrangements, the media device 300 can be a navigation system. “Navigation system” means one or more mechanisms, devices, elements, components, systems, modules, applications and/or combinations thereof, now known or later developed, configured to at least determine a current geographic location of the navigation system (or a vehicle in which the system is located) and/or determine one or more travel routes between an origin and a destination.

In one or more arrangements, the media device 300 can be operatively connected to the vehicle 400. The term “operatively connected,” as used throughout this description, can include direct or indirect connections, including connections without direct physical contact. When the media device 300 is operatively connected to the vehicle 400, it will be understood that the media device 300 can be located external to and/or remote from the vehicle 400, or the media device 300 can be located within the vehicle 400. In one or more arrangements, the media device 300 or one or more components thereof can be provided together as a unit that can be used in connection with the vehicle 400.

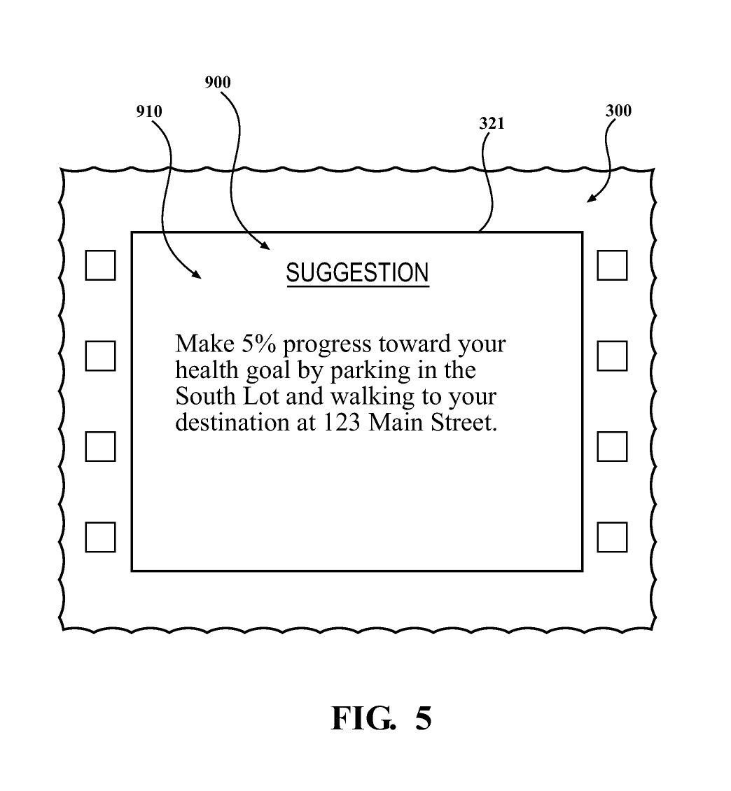

In one or more arrangements:, the media device 300 can be installed in the vehicle 400. In such case, the media device 300 or one or more components thereof can be at least a part of a head unit of the vehicle 400. Further, one or more components of the media device 300 may also serve as a component or system of the vehicle. For instance, the media device 300 may include an in-vehicle display 321 (see FIG. 5) that may also be a display or interface for a plurality of vehicle systems (e.g., a navigation system, a radio or audio system, and/or a display or monitoring system).

In one or more arrangements, the media device 300 can be a portable such that it can be selectively installed in and removed from a vehicle 400. In such case, the media device 300 can be selectively used in a plurality of vehicles. Alternatively or in addition, the media device 300 can be used as a handheld device. Alternatively or in addition, the media device 300 can be used in one or more non-vehicular applications. Alternatively or in addition, the media device 300 can be used as a standalone unit.

The vehicle 400 can be any suitable type of vehicle. As used herein, “vehicle” means any form of motorized transport, in one or more implementations, the vehicle 400 can be an automobile. While arrangements will be described herein with respect to automobiles, it will be understood that embodiments are not limited to automobiles. In one or more implementations, the vehicle 400 may be a watercraft, an aircraft or any other form of motorized transport.

The health goal suggestion module 500 can be implemented as computer readable program code that, when executed by a processor, implement one or more of the various processes described herein. The health goal suggestion module 500 can be a component of one or more processors, or the health goal suggestion module 500 can be executed on and/or distributed among other processing systems to which a processor is operatively connected. In one or more arrangements, the health goal suggestion module 500 can be a component of one or more processors of the media device 300. In one or more arrangements, the health goal suggestion module 500 can be executed on and/or distributed among other processing systems to which the media device 300 is operatively connected. For instance, the health goal suggestion module 500 can be executed on and/or distributed among at least one or more processors of the media device 300 and one or more processors of the portable communication device 200.

The health goal suggestion module 500 can include instructions (e.g., program logic) executable by a processor. Such instructions can include instructions to execute various functions and/or to transmit data to, receive data from, interact with, and/or control: the vehicle 400, one or more systems or elements of the vehicle 400, the media device 300, one or more systems or elements of the media device 300, the portable communication device(s) 200, one or more systems or elements of the portable communication device(s) 200, and/or one or more location data sources 600. Such instructions can enable the various elements of the system 100 to communicate through the communication network 700. In one or more arrangements, the health goal suggestion module 500 can include artificial or computational intelligence elements, e.g., neural network, fuzzy logic or other machine learning algorithms.

Such instructions can include instructions to obtain or otherwise receive user health information 800 (e.g., a health goal 810 and a current progress toward the health goal 820) from an application, which can be stored on, accessed by, and/or executed on the portable communication device 200. Such instructions can include instructions to determine, obtain or otherwise receive information about a destination of current vehicular travel. Such instructions can include instructions to determine one or more suggestions 910 for a user to make progress toward attaining a predetermined health goal. The determination of one or more suggestions 910 can be based on a determined destination of current vehicular travel. In one or more arrangements, such instructions can include presenting a message 900 including the determined suggestion 910 to a user. The message 900 can include additional or other information, such as providing a reminder of the health goal, the current progress toward the goal, and/or the time remaining to complete the goal, just to name a few possibilities. In one or more arrangements, one or more data stores may contain such instructions.

The one or more location data sources 600 can be any suitable source of location-related information or data. The one or more location data sources 600 can be, for example, a server, a database, a news or in formation source, an online database (e.g. a website), a publication, a system, and/or a source, as may be available from one or more public agencies (e.g. a national, state or local agency), one or more public groups (e.g. a news reporting agencies) and/or one or more private groups or companies. The system 100 can be configured to determine or obtain location-based information or data in real-time. As used herein, the term “real-time” means a level of processing responsiveness that a user or system senses as sufficiently immediate for a particular process or determination to be made, or that enables the processor to keep up with some external process.

The location data sources 600 can include any suitable information about a location. Non-limiting examples of location-related information or data that can be obtained from the one or more location data sources 600 can include: the presence of parking lots or parking garages, the distance between one or more points of a parking lots or parking garage and another point, the number of levels of as parking garage, the number of steps on each level of stairs, restaurants or other businesses near a given destination or along a travel route to a destination, information about such restaurants or other businesses.

In one or more arrangements, one or more location data sources 600 can be located onboard the vehicle 400. In one or more arrangements, one or more location data sources 600 can be location remote from the vehicle 400. In one or more arrangements, at least one location data source 600 can be located onboard the vehicle 400, and at least one location data source 600 can be located remote from the vehicle 400.

The various components of system 100 can be communicatively linked through one or more communication networks 700. As used herein, the term “communicatively linked” can include direct or indirect connections through a communication channel or pathway or another component or system. A “communication network” means one or more components designed to transmit and/or receive information from one source to another.

The one or more communication networks 700 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network 700 further can be implemented as or include one or more wireless networks, whether short or long range. For example, in terms of short range wireless networks, the communication network 700 can include a local wireless network built using a Bluetooth or one of the IEEE 802 wireless communication protocols, e.g., 802.11a/high, 802.15, 802.16, 802.20, Wi-Fi Protected Access (WPA), or WPA2. In terms of long range wireless networks, the communication network 700 can include a mobile, cellular, and or satellite-based wireless network and support voice, video, text, and/or any combination thereof. Examples of long range wireless networks can include GSM, TDMA, CDMA, WCDMA networks or the like. The communication network 700 can include wired communication links and/or wireless communication links. The communication network 700 can include any combination of the above networks and/or other types of networks The communication network 700 can include one or more routers, switches, access points, wireless access points, and/or the like.

The portable communication device 200, the media device 300, the vehicle 400, and/or the health goal suggestion module 500 can include and/or execute suitable communication software, which enables the portable communication device 200, the media device 300, the vehicle 400, and/or the health goal suggestion module 500 to communicate with each other through the communication network 110 and perform the functions disclosed herein.

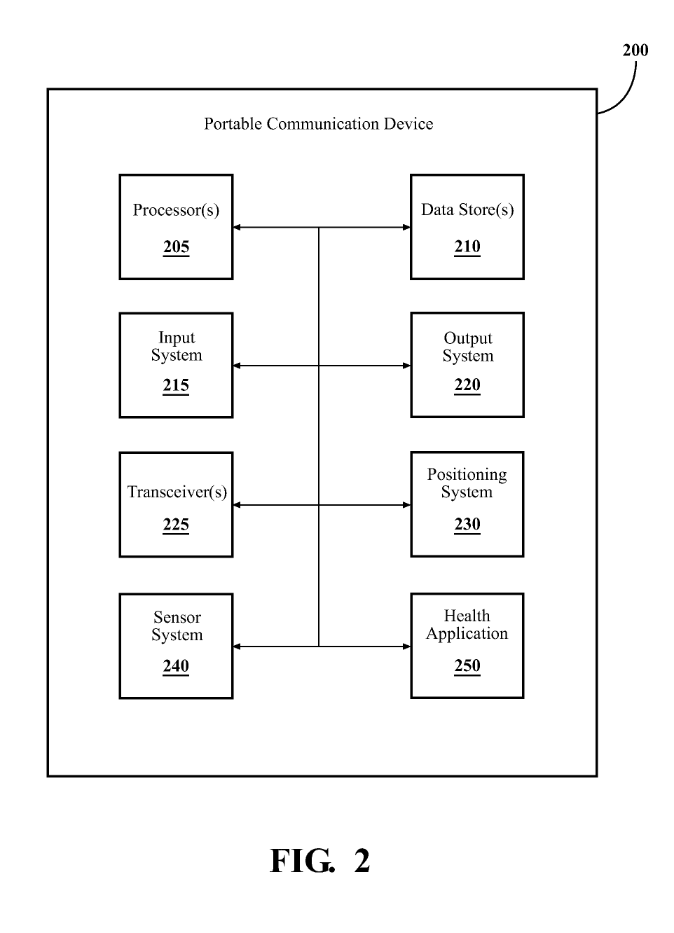

The portable communication device 200 will now be described in greater detail. Referring to FIG. 2, an example a portable communication device 200 is shown. The portable communication device 200 can be configured to provide proximity-based location alerts as described herein. The portable communication device 200 can include various elements. Some of the possible elements of the portable communication device 200 are shown in FIG. 2 and will now be described. It will be understood that it is not necessary for the portable communication device 200 to have all of the elements shown in FIG. 2 or described herein. The portable communication device 200 can have any combination of the various elements shown in FIG. 2. Further, the portable communication device 200 can have additional elements to those shown in FIG. 2. In some arrangements, portable communication device 200 may not include one or more of the elements shown in FIG. 2.

Further, the various elements are shown as being located within the portable communication device 200 in FIG. 2, but it will be understood that one or more of these elements can be located external to the portable communication device 200. Further, the elements shown may be physically separated by large distances. It should be appreciated that although particular elements are separately defined, each or any of the elements or portions thereof may be otherwise combined or segregated via hardware author software.

The portable communication device 200 can include one or more processors 205. As used herein, “processor” means one or more components that are configured to execute any of the processes described herein or any form of instructions to carry out such processes or cause such processes to be performed. The components ma be disparate parts or part of a whole unit and may not necessarily be located in the same physical location. The processor 205 may be implemented with one or more general-purpose and/or one or more special-purpose processors. In arrangements in which there is a plurality of processors 205, such processors 205 can work independently from each other or one or more processors can work in combination with each other.

Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor 205 can include at least one hardware circuit (e.g., an integrated circuit) configured to carry out instructions contained in program code.

The portable communication device 200 can include one or more data stores 210 for storing one or more types of data. The one or more data stores 210 can include volatile and/or non-volatile memory. Examples of suitable data stores 210 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof The one or more data stores 210 can be operatively connected to the processor 205 for use thereby.

The portable communication device 200 can include an input system 215. An “input system” is defined as any device, component, system, element or arrangement or groups thereof that enable information/data to be entered into a machine. The input system 215 can receive an input from a portable communication device occupant (e.g. a driver or a passenger). Any suitable input system 215 can be used, including, for example, a keypad, display, touch screen, multi-touch screen, button, joystick, mouse, trackball, microphone and/or combinations thereof.

The portable communication device 200 can include an output system 220. An “output system” is defined as any device, component, system, element or arrangement or groups thereof that enable information/data to be presented. The output system 220 can present information/data to a portable communication device occupant. For instance, the output system 220 can include a display, a microphone, earphone, and/or speaker. Some components of the portable communication device 200 may serve as both a component of the input system 215 and a component of the output system 220.

In one or more arrangements, the output system 220 can be configured to provide a haptic output to a user. “Haptic output” is any output that is perceptible to the human sense of touch. The haptic output can be presented using the any suitable element, such as one or more haptic actuators. The one or more haptic actuators can include motors, pneumatic actuators, hydraulic pistons, relays, solenoids, and/or piezoelectric actuators, just to name a few possibilities. The haptic output can have any suitable form. For instance, the haptic output can be presented by causing a vibration of the portable communication device 200. However, it will be understood that the haptic output is not limited to vibrations.

The portable communication device 200 can include one or more transceivers 225. As used herein, “transceiver” is defined as a component or a group of components that transmit signals, receive signals or transmit and receive signals, whether wirelessly or through a hard-wired connection. The one or more transceivers 225 can be operatively connected to the one or more processors 205 and/or the one or more data stores 210.

The one or more transceivers 225 can enable communications between the portable communication device 200 and the media device 300. The one or more transceivers 225 can be any suitable transceivers used to access a network, access point, node or other device (e.g., media device 300) for the transmission and receipt of data. The transceiver 225 may be a wireless transceiver using any one of a number of wireless technologies. Examples of suitable transceivers include a cellular transceiver, broadband Internet transceiver, local area network (LAN) transceiver, wide area network (WAN) transceiver, wireless local area network (WLAN) transceiver, personal area network (PAN) transceiver, body area network (BAN) transceiver, WiFi transceiver, WiMax transceiver, Bluetooth transceiver, 3G transceiver, 4G transceiver, ZigBee transceiver. WirelessHART transceiver, MiWi transceiver, IEEE 802.11 transceiver, IEEE 802.15.4 transceiver, or a Near Field Communication (NFC) transceiver, just to name a few possibilities. The one or more transceivers 225 can include any wireless technology developed in the future. Again, the one or more transceivers 225 can be any suitable combination of transceivers, including any combination of the transceivers noted above.

The portable communication device 200 can include a positioning system 230. The positioning system 230 can include one or more mechanisms, devices, elements, components, systems, applications and/or combinations thereof, now known or later developed, configured to determine the geographic location el the portable communication device 200. The positioning system 230 can include one or more mapping applications and/or have access to map data.

The positioning system 230 can include a global positioning system, a local positioning system or a geolocation system. The positioning system 230 can be implemented with any one eta number of satellite positioning systems, such as the United States Global Positioning System (GPS), the Russian Glonass system, the European Galileo system, the Chinese Beidou system, or any system that uses satellites from a combination of satellite systems, or any satellite system developed in the future, including the planned Chinese COMPASS system and the Indian Regional Navigational Satellite System. Further, the positioning system 230 can use Transmission Control Protocol (TCP) and/or a Geographic information system (GIS) and location services.

The positioning system 230 may include a transceiver configured to estimate a position of the portable communication device 200 with respect to the Earth. For example, the positioning system 230 can include at PS transceiver to determine the portable communication device's latitude, longitude and/or altitude. The positioning system 230 can use other systems (e.g. laser-based localization systems, inertial-aided GPS, and/or camera-based localization) to determine the location of the portable communication device 200.

Alternatively or in addition, the positioning system 230 can be based on access point geolocation services, such as using the W3C Geolocation Application Programming Interface (API). With such a system, the location of the portable communication device 200 can be determined through the consulting of location information servers, including, fix example. Internet protocol (IP) address, Wi-Fi and Bluetooth Media Access Control (MAC) address, radio-frequency identification (RFID), Wi-Fi connection location, or device GPS and Global System for Mobile Communications (GSM)/code division multiple access (CDMA) cell IDs. Thus, it will be understood that the specific manner in which the geographic position of the portable communication device 200 is determined will depend on the manner of operation of the particular location system used.

The portable communication device 200 can include a sensor system 240. The sensor system 240 can include one or more sensors. “Sensor” means any device, component and/or system that can detect, determine, assess, monitor, measure, quantify and/or sense something. The one or more sensors can be configured to detect, determine, assess, monitor, measure, quantify and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 240 includes a plurality of sensors, the sensors can work independently from each other. Alternatively, two or more of the sensors can work in combination with each other. The sensor system 240 and/or the one or more sensors can be operatively connected to the processor(s) 205, the data store(s) 210, and/or other element(s) of the portable communication device 200.

The sensor system 240 can include any suitable type of sensor. For example, the sensor system 240 can include one or more sensors configured to detect, determine, assess, monitor, measure, quantify and/or sense information about a user's progress toward attaining a health goal. In one or more arrangements, the sensor system 240 can include a pedometer, speedometer, step tracker, heart rate monitor, motion sensor, blood sugar level monitor, calorie burn tracker, activity level tracker, an electrodermal activity (EDA) monitor, a galvanic skin response (GSR) monitor, an electroencephalograph (EEG), an electrocardiograph (ECG), an electromyograph (EMG), an electronystagmograph (ENG), and/or nutrition tracker, just to name a few possibilities. In one or more arrangements, the sensor system 240 can include one or more cameras. It will be understood that the embodiments are not limited to the particular sensors described.

A health application 250 can be on the portable communication device 200. “On the portable communication device” means that the application is installed on, stored on, executed on, and/or accessed for display on the portable communication device 200. An “application” is defined as a program or programs that perform one or more particular tasks an a computing device (e.g., a portable communication device). Examples of an application include programs that may present a user interface for interaction with a user or that may run in the background of an operating environment that may not present a user interface while in the background. A “health application” is defined as a program or programs that perform one or more particular tasks relating to the health of a user on a computing device.

The health application 250 can include instructions (e.g., program logic) executable by one or more of the processors 205. Such instructions can include instructions to execute various portable communication device functions and/or to transmit data to, receive data from, interact with, and/or control the portable communication device, one or more systems thereof, and/or other device (e.g., the media device 300). The health application 250 can be configured to enable a health goal to be set by a user or some other entity. The health goal can be any suitable goal and can be defined in any suitable manner. Non-limiting examples of the health goal include: a certain number of steps, a certain number of stair steps, an activity level, an exercise level, calories consumed, calories burned, a predetermined distance, and/or healthy eating, just to name a few possibilities. In one or more arrangements, the health goal can be for a predetermined period of time. For instance, the health goal can be yearly, semi-annually, quarterly, monthly, weekly, daily, hourly, or other suitable time period. In one or more arrangements, at least some of the health goals e.g., certain number of steps, certain number of stair steps, predetermined distance, etc.) an be achieved by self-propelled motion (e.g., walking running, jogging, hiking, swimming, etc.).

The health application 250 can be configured to track a user's progress toward the health goal. For instance, the health application 250 can be operatively connected to receive data from the sensor system 240 or other element of the portable communication device 200 to track user's progress toward the health goal. As another example, the health application can be configured to receive data input by the user with respect to the user's progress toward the health goal, such as by using the input system 215.

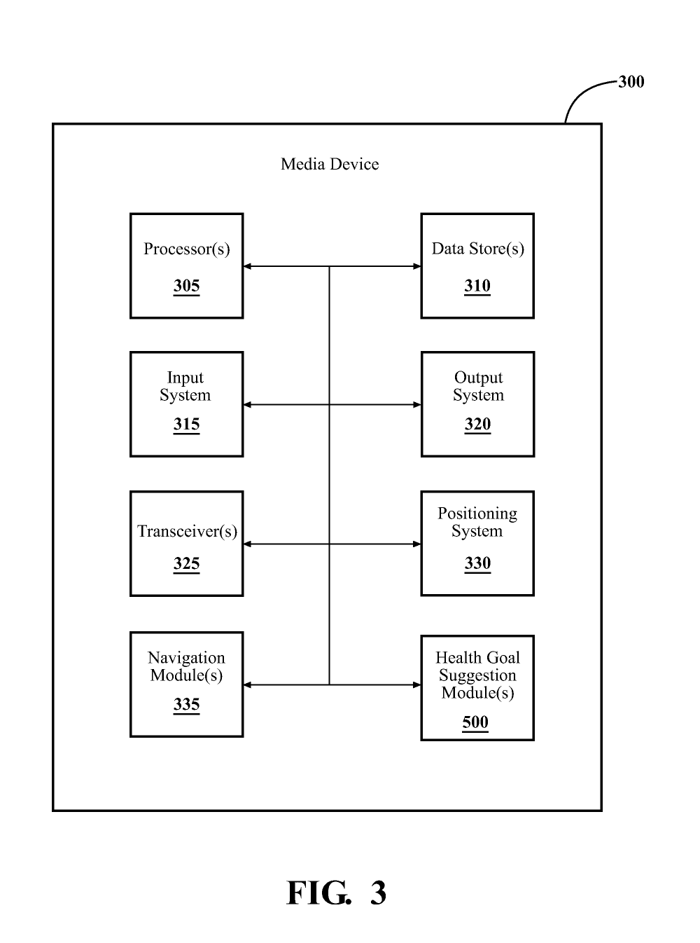

Referring to FIG. 3, an example of the media device 300 is shown. Some of the possible elements of the media device 300 are shown in FIG. 3 and will now be described. It will be understood that it is not necessary for the media device 300 to have all of the elements shown in FIG. 3 or described herein. The media device 300 can have any combination of the various elements shown in FIG. 3. Further, the media device 300 can have additional elements to those shown in FIG. 3. In some arrangements, the media device 300 may not include one or more of the elements shown in FIG. 3. The various elements of the media device 300 can be operatively connected to each other in any suitable manner. Further, the elements shown may be physically separated by large distances.

The media device 300 can include one or more processors 305, one or more data stores 310, an input system 315, an output system 320, one or more transceivers 325, and/or a positioning system 330. The above description of the one or more processors 205, the one or more data stores 210, the input system 215, the output system 220, the one or more transceivers 225, and/or the positioning system 230 made in connection with the portable communication device 200 applies equally to the one or more processors 305, the one or more data stores 310, the input system 315, the output system 320, the one or more transceivers 325, and/or the positioning system 330, respectively, of the media device 300.

In one or more arrangements, the media device 300 can include a navigation module 355. The navigation module 355 can be implemented as computer readable program code that, when executed by a processor, implement various processes described herein. For instance, the navigation module 355 can be configured to determine a current geographic location of the media device 300, determine one or more travel routes between an origin and a destination, and/or determine one or more revised travel routes based on a changed condition (e.g. route, location, traffic, accidents, road closures, etc.). However, it will be understood that the navigation module 355 can be configured to determine other things as well.

The navigation module 335 can be a component of and/or executed on the processor 305, or the navigation module 335 can be executed on and/or distributed among other processing systems to which the processor 305 is operatively connected. The navigation module 335 can include instructions (e.g., program logic) executable by the processor 305. Alternatively or in addition, the data store 310 may contain such instructions.

In one or more arrangements, the navigation module 335 can include, have access to and/or can execute one or more mapping applications or map data to determine a travel route between an origin and a destination. The origin or destination can be provided in any suitable manner. For instance, a user may input an origin and/or a destination. Alternatively or in addition, the navigation module 335 may obtain the origin and/or the destination in any suitable manner and/or from any suitable source. The mapping application can determine one or more suitable travel routes between the origin and the destination. A travel route may be selected based on one or more parameters (e.g. shortest travel distance, shortest amount of travel time, etc.). Such parameters can be configured by a user or by some other entity.

The health goal suggestion module 500 can be implemented as computer readable program code that, when executed by a processor, implement one or more of the various processes described herein. The health goal suggestion module 500 can be a component of one or more processors, or the health goal suggestion module 500 can be executed on and/or distributed among other processing systems to which a processor is operatively connected. In one or more arrangements, the health goal suggestion module 500 can be a component of one or more processors of the media device 300. In one or more arrangements, the health goal suggestion module 500 can be executed on and/or distributed among other processing systems to which the media device 300 is operatively connected. For instance, the health goal suggestion module 500 can be executed on and/or distributed among at least one or more processors of the media device 300 and one or more processors of the portable communication device 200.

The health goal suggestion module 500 can include instructions (e.g., program logic) executable by a processor. Such instructions can include instructions to execute various vehicle functions and/or to transmit data to, receive data from, interact with, and/or control the vehicle 400, one or more systems of the vehicle 400, the portable communication device(s) 200, one or more systems of the portable communication device(s) 200, and/or one or more location data sources 600. Such instructions can enable the various elements of the system 100 to communicate through the communication network 110.

The health goal suggestion module 500 can include instructions (e.g., program logic) executable by a processor. Such instructions can include instructions to execute various functions and/or to transmit data to, receive data from, interact with, and/or control: the vehicle 400, one or more systems or elements of the vehicle 400, the media device 300, one or more systems or elements of the media device 300, the portable communication device(s) 200, one or more systems or elements of the portable communication device(s) 200, and/or one or more location data sources 600. Such instructions can enable the various elements of the system 100 to communicate through the communication network 700. In one or more arrangements, one or more data stores may contain such instructions.

Such instructions can include instructions to determine one or more suggestions for a user to make further progress toward attaining a predetermined health goal based on a determined destination of the vehicle 400. To determine a suggestion, the health goal suggestion module 500 can obtain or otherwise receive data from one or more sources. Such instructions can include instructions to obtain or otherwise receive user health information 800 (e.g., a health goal 810 and a current progress toward the health goal 820) from the application 250, which can be stored on, accessed by, and/or executed on the portable communication device 200. Such instructions can include instructions to determine, obtain or otherwise receive information about a destination of current vehicular travel, such as by obtaining or otherwise receiving information from one or more location data sources 600.

Such instructions can include instructions to determine one or more suggestions 910 for a user to make progress toward attaining a predetermined health goal. The determination of one or more suggestions 910 can be based on a determined destination of current vehicular travel. In one or more arrangements, such instructions can include presenting a message 900 to a user. The message can include the determined suggestion 910. The message 900 can include additional or other information, such as providing a reminder of the health goal, the current progress toward the goal, and/or the time remaining to complete the goal, just to name a few possibilities. In one or more arrangements, one or more data stores may contain such instructions.

Such instructions can include instructions to vary the content or tone of the message 900 as the user approaches and/or achieves the health goal. For instance, the instructions can include, responsive to determining that a health goal is met, the message 900 can be a positive message (e.g., a congratulatory message, a graphical award or trophy, celebratory music or sounds, etc.). As another example, the tone of the message 900 can vary based on the user's progress toward the health goal. For instance, the tone of the message 900 can become more positive as the user gets closer to attaining the health goal.

In one or more arrangements, the health goal suggestion module 500 can include artificial or computational intelligence elements, e.g., neural network, fuzzy logic or other machine learning algorithms. Thus, in one or more arrangements, the health goal suggestion module 500 can be configured to predict a destination of current vehicular travel based on historical travel data or other data. For instance, the health goal suggestion module 500 can obtain historical travel data or other data from the media device 300 or a component thereof (e.g., the positioning system 330 and/or the navigation module 335). Over time, the health goal suggestion module 500 may learn that a user travels to a particular destination—Destination A—on one or more days substantially at the same time of day. Based on such history, the health goal suggestion module 500 may predict that the user is traveling to Destination A if substantially the same historical conditions are met.

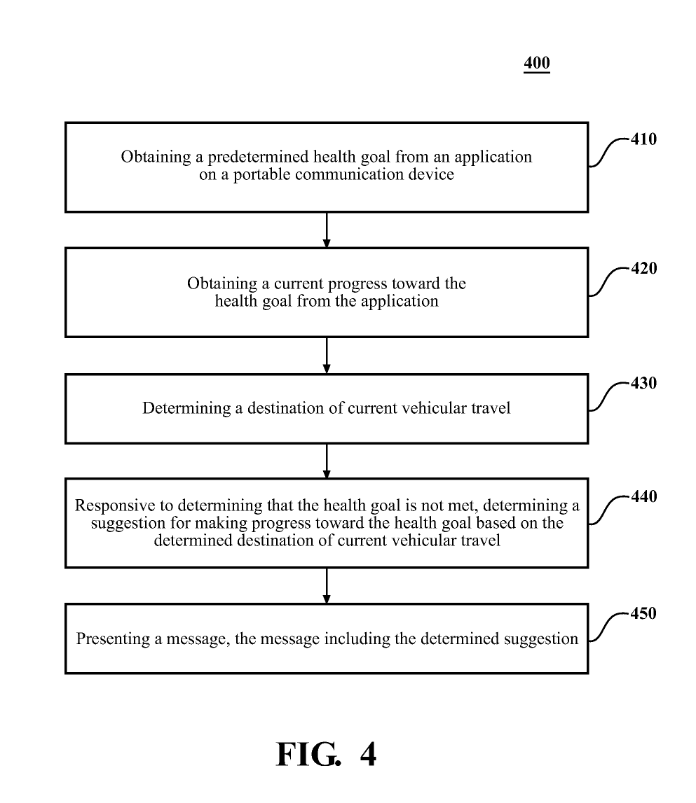

Now that the various potential systems, devices, elements and/or components have been described, various methods for assisting a user in attaining a health goal will now be described. Referring now to FIG. 4, one example of a method for assisting a user in attaining a health goal is shown. Various possible steps of method 400 will now be described. The method 400 illustrated in FIG. 4 may be applicable to the embodiments described above in relation to FIGS. 1-3, but it is understood that the method 400 can be carried out with other suitable systems and arrangements. Moreover, the method 400 may include other steps that are not shown here, and in fact, the method 400 is not limited to including every step shown in FIG. 4. The steps that are illustrated here as part of the method 400 are not limited to this particular chronological order. Indeed, some of the steps may be performed in a different order than what is shown and/or at least some of the steps shown can occur simultaneously.

At block 410, the predetermined health goal 810 can be obtained from the application 250 on the portable communication device 200. The predetermined health goal 810 can be obtained from the application 250 in any suitable manner. As an example, the health goal suggestion module 500 can query the application 250 or otherwise request such data or information about the predetermined health goal 810 be sent by the application 250. The predetermined health goal 810 can be sent by the application 250 in response to such requests. Alternatively, the predetermined health goal 810 can be sent by the application 250 automatically when communication between the application 250 and the health goal suggestion module 500 is established and/or at any other suitable time. In one or more arrangements, the predetermined health goal 810 can be accessed and/or extracted from the application 250 by the health goal suggestion module 500. The method 400 can continue to block 420.

At block 420, the user's current progress 820 toward the health goal can be obtained from the application 250 on the portable communication device 200. The current progress 820 can be obtained from the application 250 in any suitable manner. As an example, the health goal suggestion module 500 can query the application 250 or otherwise request such data or information about the current progress 820 be sent by the application 250. The current progress 820 can be sent by the application 250 in response to such requests. Alternatively, the current progress 820 can be sent by the application 250 automatically when communication between the application 250 and the health goal suggestion module 500 is established and/or at any other suitable time. In one or more arrangements, the current progress 820 can be accessed and/or extracted from the application 250 by the health goal suggestion module 500. The method 400 can continue to block 430.

At block 430, a destination of current vehicular travel can be determined. In one or more arrangements, the destination of current vehicular travel can be input by a user. In one or more arrangements, the destination of current vehicular travel can be predicted based on user driving history data. Such predicting can be performed by the health goal suggestion module 500 and/or the navigation module 335. The destination of current vehicular travel can be obtained from the media device 300 (e.g., the navigation module 335) in any suitable manner. As an example, the health goal suggestion module 500 can query the navigation module 335 or otherwise request such data or information be sent by the navigation module 335. Such data or information can be sent by the navigation module 335 in response to such requests. Alternatively, the destination information or data can be sent by the navigation module 335 automatically when communication between the navigation module 335 and the health goal suggestion module 500 is established and/or at any other suitable time. In one or more arrangements, the destination information can be accessed and/or extracted from the navigation module 335 by the health goal suggestion module 500. The method 400 can continue to block 440.

At block 440, responsive to determining that the health goal 810 is not met, one or more suggestions 910 for making progress toward the health goal 810 can be determined based on the determined destination of current vehicular travel. Such a determination can be made by the health goal suggestion module 500. The health goal suggestion module 500 can obtain or otherwise receive location information from one or more location data source 600. The health goal suggestion module 500 can process such information to determine one or more suggestion 910 for making progress toward the health goal 810. The method 400 can continue to block 450.

At block 450, a message 900 can be presented. The message 900 can include the determined suggestion. In one or more arrangements, the health goal suggestion module 500 can present the message 900 or can cause the message 900 to be presented. For instance, the health goal suggestion module 500 can cause the message 900 to be presented on the output system 320 (e.g., a display 321 (FIG. 5)) of the media device 300. As another example, the health goal suggestion module 500 can cause the message 900 to be presented on the output system 220 of the portable communication device 200.

The message 900 can include the suggestion 910. In some instances, the message 900 can include additional or alternative content. For instance, the message 900 can be a reminder of the health goal 810.

The message 900 can be presented at any suitable time. In one or more arrangements, the message 900 can be presented when the suggestion 910 is determined. In one or more arrangements, the message 900 can be presented when the destination of current vehicular travel is substantially reached. “Substantially reached” means that the vehicle is located within a predetermined distance from the destination.

The method 400 can end. Alternatively, the method 400 can return to block 410. The method 400 can repeat at any suitable point, such as at a suitable time or upon the occurrence of any suitable event or condition. As a further alternative, the method 400 can include additional and/or alternative blocks (not shown). For instance, responsive to determining that the health goal 810 is met, a positive message or indicator can be presented to the user.

A non-limiting example of assisting a user in attaining a health goal in accordance with systems and methods described, herein will now be presented. A user may have a smartphone or other portable communication device 200 with a health related application 250 thereon. For purposes of this example, the application 250 can be configured to track a user's steps. The health goal 810 can be a certain number of steps per day. As the user goes about his or her day, the application 250 can track the user's progress, using as by obtaining and/or processing data from the sensor system 240 of the portable communication device 200.

The user may enter his or her vehicle 400 to drive to a point of interest (e.g., a store). The user may program the store's address or other information into the media device 300 (e.g., a navigation system) in the vehicle 400. The user can be carrying his or her portable communication device 200. The health goal suggestion module 500 can be communicatively linked with the application 250. The health goal suggestion module 500 can obtain the health goal 810 and the user's current progress 820 toward the health goal 810 from the application 250. The health goal suggestion module 500 can determine the destination of current vehicular travel from the media device 300.

If the user has not met the health goal 810, the health goal suggestion module 500 can determine a suggestion 910 for making full or partial progress toward attaining the health goal 810. The suggestion 910 can be determined based on the determined destination of current vehicular travel. To make such a determination, the health goal suggestion module 500 can obtain information from one or more location data sources 600. For instance, in this example, the location data sources 600 can include map information at or near the destination. Such information can include the presence of one or more parking lots or one or more parking garages. Such information can include or the health goal suggestion module 500 can determine the distance from the parking lot(s) or parking garage(s) or regions thereof to the destination.

Based on such information, the health goal suggestion module 500 can determine that a user can make progress toward the health goal 810 by parking in a particular parking lot near the destination and walking to the destination. In one or more arrangements, the health goal suggestion module 500 can determine, estimate, or predict the amount of progress that a user can make toward his or her goal if he or she follows the suggestion. Alternatively, the health goal suggestion module 500 can determine that a user can make progress toward the health goal 810 by parking a vehicle a certain distance from the destination.

A message 900 can be presented to the user. The message 900 can include the determined suggestion 910. The message 900 can be presented in any suitable manner. For instance, the message 900 can be presented as an audial message and/or as a visual message. FIG. 5 shows one example in which the message 900 is presented as a visual message on a display 321 of the media unit 300. A “display” is defined as a component or a group of components that present information/data in visual form, including, for example, video, images, graphics, etc. The message 900 can have any suitable form, content and features. Thus, it will be understood that the message 900 shown in FIG. 5 is provided merely as an example and is not intended to be limiting.

The display 321 can be a part of the output system 320 and/or the input system 315 of the media device 300. The display 321 can be any suitable type of display. The display 321 can be any suitable type of display. For instance, the display 321 can be a liquid, crystal display (LCD), a light emitting diode (LED) display or some other suitable display. In one or more arrangements, the forward display 321 can be a touch screen display, a multi-touch display or a remotely controlled display. A touch screen can allow a user to engage or interact with one or more displayed elements, such as a graphical user interface (GUI), and/or other applications running on any vehicle system, including any of those described herein, through contact with the forward display 321. For example, a user may make selections and move a cursor by simply touching the forward display 321 via a finger or stylus.

In some arrangements, the display 321 can be a portion of another vehicle system, such as a navigation system, a vehicle radio or audio system, a backup camera display and/or other vehicle monitor. In one or more arrangements, the display 321 can be located in a front interior portion of a vehicle. For instance, the display 321 can be included in a dashboard or instrument panel (not shown) of a vehicle.

The user can decide whether or not to follow the suggestion 910. If the user follows the suggestion, the application 250 can track the user's progress toward the health goal 810. When the user returns to the vehicle 400, the health goal suggestion module 500 can determine another suggestion for the user to make progress toward the health goal 810.

Again it will be understood that the above description of a certain number of steps per day is merely one example of a health goal. As another example, the predetermined health goal can a predetermined number of stair steps by self-propelled motion. In such case, the suggestion is parking on a particular floor of a parking garage and to use the stairs. As a further example, the predetermined health goal can be eating healthy food or a certain number of healthy meals per day. In such case, the suggestion can be one or more restaurants near the destination of current vehicular travel. Alternatively or in addition, the suggestion can be avoiding one or more restaurants near the destination of current vehicular travel that are determined to he inconsistent with the health goal.

It will be appreciated that arrangements described, herein can provide numerous benefits, including one or more of the benefits mentioned herein. For example, arrangements described herein can assist a user in meeting his or her health goals. Arrangements described herein can provide suggestions for attaining the health goals in a location-relevant manner. Arrangements described herein can provide suggestions for attaining the health goals in a timely and/or convenient manner.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical functions). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media haying computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A method for assisting a user in attaining a health goal, comprising
obtaining a predetermined health goal from an application on a portable communication device;
obtaining a current progress toward the health goal from the application;
determining a destination of current vehicular travel;
responsive to determining that the health goal is not met, determining a suggestion for making progress toward the health goal based on the determined destination of current vehicular travel; and
presenting a message, the message including the determined suggestion.

2. The method of claim 1, wherein the predetermined health goal is a predetermined distance or a predetermined number of steps by self-propelled motion, and wherein the suggestion is parking a vehicle a certain distance from the destination of current vehicular travel.

3. The method of claim 1, wherein the predetermined health goal is a predetermined distance or a predetermined number of steps by self-propelled motion, and wherein the suggestion is parking a vehicle in a particular location.

4. The method of claim 1, wherein the predetermined health goal, is a predetermined number of stair steps by self-propelled motion, and wherein the suggestion is parking on a particular floor of a parking garage and to use the stairs.

5. The method of claim 1, wherein the health goal is eating healthy food, and wherein the suggestion is one or more restaurants near the destination of current vehicular travel.

6. The method of claim 1, wherein the health goal is eating healthy food, and wherein the suggestion is avoiding one or more restaurants near the destination of current vehicular travel that are determined to be inconsistent with the health goal.

7. The method of claim 1, wherein determining the destination of current vehicular travel includes determining the destination of current vehicular travel based on a user input.

8. The method of claim 1, wherein determining the destination of current vehicular travel includes predicting the destination of current vehicular travel based on user driving history data.

9. The method of claim 1, further including:
responsive to determining that a health goal is met, presenting a positive indicator to the user.

10. The method of claim 1, wherein presenting the message to the user is performed when the destination of current vehicular travel is substantially reached.

11. A system configured to assist a user in attaining a health goal, the system comprising:
a media device, the media device including:
a processor, the processor being programmed to initiate executable operations comprising:
obtaining a predetermined health goal from an application on a portable communication device;
obtaining a current progress toward the health goal front the application;
determining a destination of current vehicular travel;
responsive to determining that the health goal is not met, determining a suggestion for making progress toward the health goal based on the determined destination of current vehicular travel; and
presenting a message, the message including the determined suggestion.

12. The system of claim 11, wherein the media device further includes:
a display Operatively connected to the processor, wherein the Message is presented On the display.

13. The system of claim 11, wherein the media device is a navigation system.

14. The system of claim 11, wherein the predetermined health goal is a predetermined distance or a predetermined number of steps by self-propelled motion, and wherein the suggestion is one of:
parking a vehicle a certain distance front the destination of current vehicular travel, or
parking a vehicle in a particular location.

15. The system of claim 11, wherein the predetermined health goal is a predetermined number of stair steps by self-propelled motion, and wherein the suggestion is parking on a particular floor of a parking garage and to use the stairs.

16. The system of claim 11, wherein the health goal is eating healthy food, and wherein the suggestion is one of:
one or more restaurants near the destination of current vehicular travel, or
avoiding one or more restaurants near the destination of current vehicular travel that are determined to be inconsistent with the health goal.

17. The system of claim 11, wherein determining the destination of current vehicular travel includes determining the destination of current vehicular travel based on a user input.

18. The system of claim 11, wherein determining the destination of current vehicular travel includes predicting the destination of current vehicular travel based on user driving history data

19. The system of claim 11, further including:
a vehicle, wherein the media device is located in the vehicle.

20. A computer program product for assisting a user in attaining as health goal, the computer program product comprising a computer readable storage medium having program code embodied therein, the program code executable by a processor to perform a method comprising:
obtaining a predetermined health goal from an application on a portable communication device:
obtaining a current progress toward the health goal from the application;
determining a destination of current vehicular travel;
responsive to determining that the health goal is not met, determining a suggestion for making progress toward the health goal based on the determined destination of current vehicular travel; and
presenting a message, the message including the determined suggestion.
